(19) United States
(12) Patent Application Publication
(10) Pub. No.: US 2024/0183452 A1
(43) Pub. Date: Jun. 6, 2024

(54) High Temperature Gate Valve

(71) Applicant: Dril-Quip, Inc., Houston, TX (US)

(72) Inventors: Matthew Thomas Robinson Webster, Edmonton (CA); Christopher William Hebert, Edmonton (CA)

(21) Appl. No.: 18/522,926

(22) Filed: Nov. 29, 2023

Related U.S. Application Data
(60) Provisional application No. 63/429,419, filed on Dec. 1, 2022.

(51) Int. Cl. F16K 3/30

(52) U.S. Cl. CPC F16K 3/30

(57) ABSTRACT

A gate valve has a valve body defining a flow passage. The valve body has an inner cavity and a gate guide that traverses the flow passage. The valve body includes an upstream valve seat and a downstream valve seat on opposed sides of the gate guide, where each of the upstream valve seat and the downstream valve seat circumscribe the flow passage. A valve gate moves along the gate guide between an open position in which the valve gate engages the downstream valve seat and the upstream valve seat and permits fluid flow along the flow passage and a closed position in which the valve gate blocks fluid flow along the flow passage. A drain passage has an inlet in fluid communication with the inner cavity and an outlet in fluid communication with the flow passage downstream of the gate guide.

### CROSS-REFERENCE TO RELATED APPLICATIONS

The present application claims priority to U.S. Provisional Patent Application No. 63/429,419, filed on Dec. 1, 2022, the content of which is hereby incorporated by reference in its entirety.

### TECHNICAL FIELD

This relates to a gate valve, and in particular, a gate valve with a drain passage between a valve body and a downstream flow passage.

### BACKGROUND

In high temperature applications, elastomeric seals typically used in valves tend to fail. In these cases, it may be necessary to use a valve with a metal-to-metal seal. One common type of valve is a gate valve, an example of which is shown in FIGS. 1 and 2. Gate valve, indicated generally by reference number 100, has a valve body 102 that houses a valve gate 104, which moves perpendicularly along a valve guide 106 between an open position shown in FIG. 1 and a closed position shown in FIG. 2. Gate valve 100 is designed for high temperature applications and is designed to reduce the thermal exposure to temperature-sensitive components.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view in section of a prior art gate valve in an open position.

FIG. 2 is a side elevation view in section of a prior art gate valve in a closed position.

FIG. 3 is a side elevation view in section of a gate valve with a drain passage, where the gate valve is in an open position.

FIG. 4 is a side elevation view in section of a gate valve with a drain passage, where the gate valve is in a closed position.

FIG. 5 is a detailed side elevation view in section of a gate valve with an alternate valve seat, where the gate valve is in an open position.

FIG. 6 is a detailed side elevation view in section of a gate valve with an alternate valve seat, where the gate valve is in a closed position.

FIG. 7 is a detailed side elevation view in section of a gate valve with a further alternate valve seat, where the gate valve is in an open position.

FIG. 8 is a detailed side elevation view in section of a gate valve with a further alternate valve seat, where the gate valve is in a closed position.

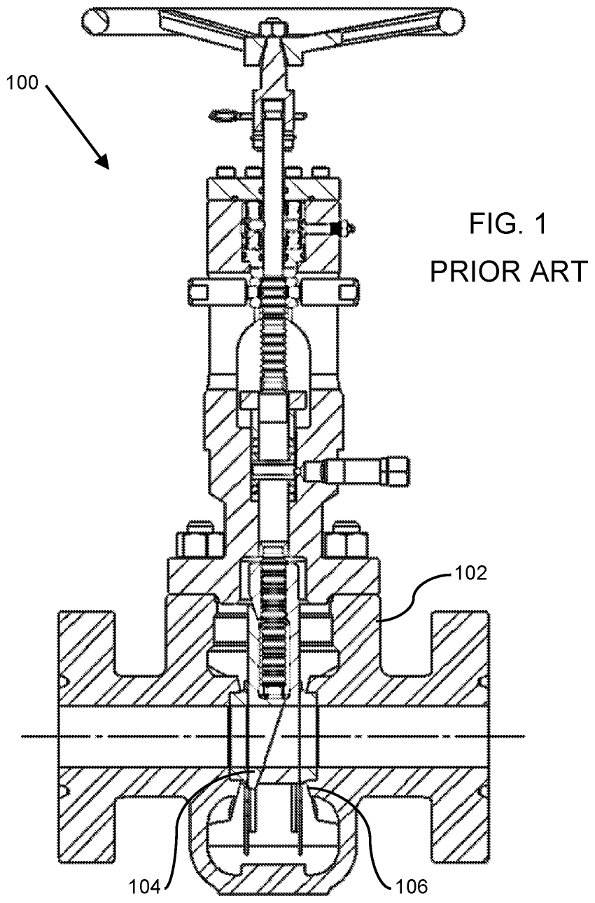

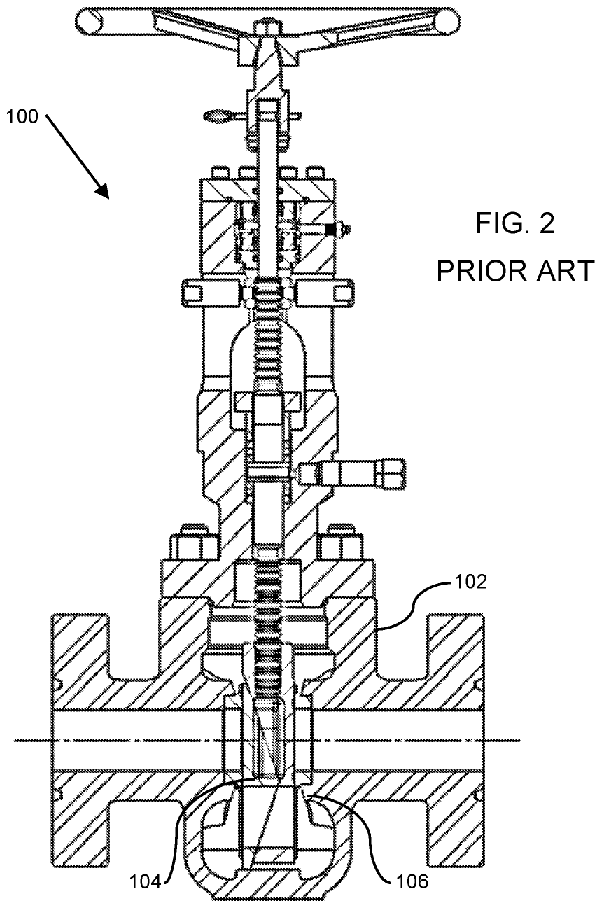

### DETAILED DESCRIPTION OF PREFERRED EMBODIMENTS

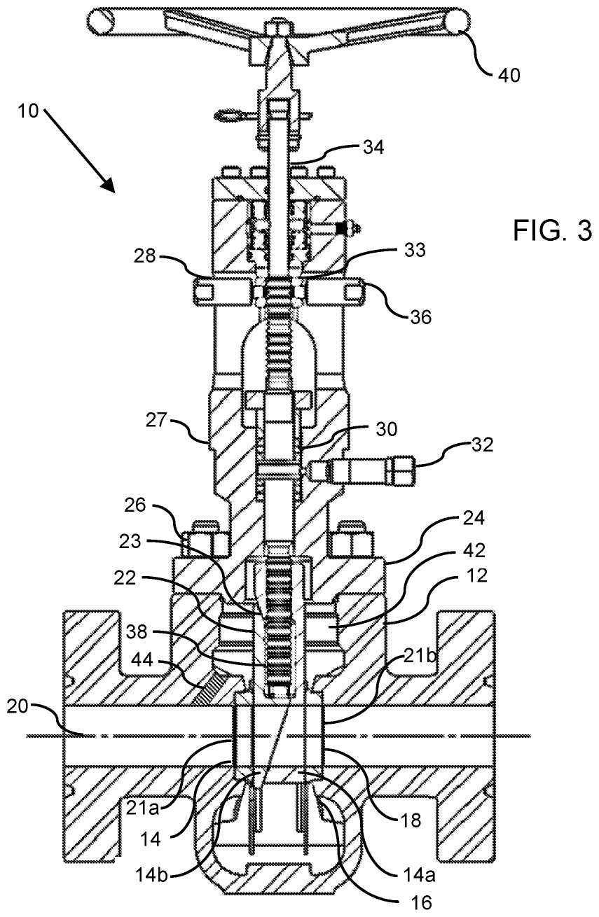

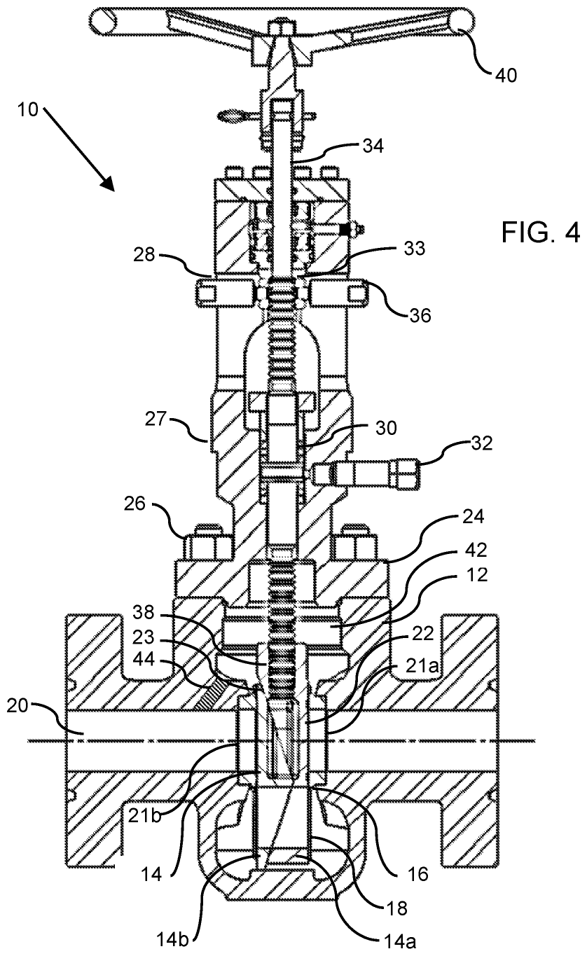

Referring to FIGS. 3 and 4, a modified gate valve, indicated by reference number 10, is shown. Gate valve 10 was initially designed for use in high temperature applications, which will be understood to refer to temperature ranges at which elastomeric seals become unreliable. However, gate valve 10 may be used in circumstances in which elastomeric seals are undesirable for other reasons or in other temperature ranges.

Modified gate valve 10 has a valve body 12 that houses a valve gate 14, which moves perpendicularly along a valve guide 16 between an open position shown in FIG. 3 and a closed position shown in FIG. 4. In the depicted example, valve gate 14 includes a lower flow aperture 18 that aligns with the fluid flow path 20 in the open position, and a slab portion 22 that blocks fluid flow path 20 in the closed position. Valve gate 14 as depicted is an expanding valve gate that has an upstream portion 14a that moves relative to a downstream portion 14b along a ramp surface 23, which causes it to expand. In the closed position, an additional actuating pressure applied to valve gate 14 causes upstream portion 14a to move relative to downstream portion 14, causing it to expand and create a stronger seal against valve seats 21a and 21b, respectively, which are provided on either side of valve gate 14. The depicted gate valve 10 has a bonnet 24 mounted to valve body 12 by studs 26. Bonnet 24 may enclose a packing assembly 27 and a bearing assembly 28. Packing assembly 27 may include packing 30 and a packing injection fitting 32 and bearing assembly 28 may include bearings 33 and lubricant fittings 36. The position of valve gate 14 may be changed as valve stem 34 is rotated, causing valve gate 14 to move along a threaded portion 38 of valve stem 34. Valve gate 14 may move within a cavity 42 formed by the interior surfaces of valve body 12 and bonnet 24. Packing assembly 27 may be used to seal around valve stem 34, while bearing assembly 28 may support the rotation of valve stem 34. A hand wheel 40 may be used to rotate valve stem 34. The overall operation of the depicted gate valve 10 is shown for illustrative purposes and may be modified according to other known designs, subject to the design elements discussed below.

In valves where elastomers are not used as sealing elements, such as valves intended for use in in high temperature applications, the resulting hard surface to hard surface engagement (e.g., metal to metal) may be unable to provide as good of a seal without additional force pressing these surfaces together, and the likelihood of fluid leaking past valve gate 14 and into the cavity 42 is increased. It has also been found that the mechanical force provided by the gate expansion may be insufficient to provide this additional force at higher pressures, such as pressures above 2000 psi. It has also been found that, if downstream valve seat 21b is sealing at low pressure while the upstream pressure increases, the seal between valve gate 14 and downstream valve seat 21b may be maintained while the risk of a leak between valve gate 14 and upstream valve seat 21a may increase. If a sufficient amount of fluid leaks past valve gate 14, fluid may also leak from valve body 12 or bonnet 24, or a blowout may occur at high pressures. This risk of blowout is further increased if the thermal expansion of the fluids in body cavity 42 occurs at high temperatures, as this can increase the entrained pressure in body cavity 42 beyond the design pressure of valve 10. To reduce these risks, a drain passage 44 may be provided in communication with cavity 42 and the downstream portion of flow path 20. A shown, drain passage 44 is machined through an interior surface of valve body 12 as a bypass around the downstream valve seat 21b. Drain passage 44 may be formed in any suitable location that allows fluid to drain from cavity 42 to the downstream portion of passage 20, such as in downstream valve seat 21b. Drain passage 44 may be provided on the downstream side of valve gate 14 because, if placed on the upstream side, the fluid and contaminants from the blocked flow stream may enter valve cavity 42 and impair the performance of valve 10. If drain passage 44 is provided on the downstream side of valve gate 14, the pressure-aided sealing required to affect the metal-to-metal seal is not provided, meaning the valve may not seal at high pressures. Design features will be discussed below that may help improve the seal on upstream valve seat 21a so that drain passage 44 across downstream valve seat 21b may be provided.

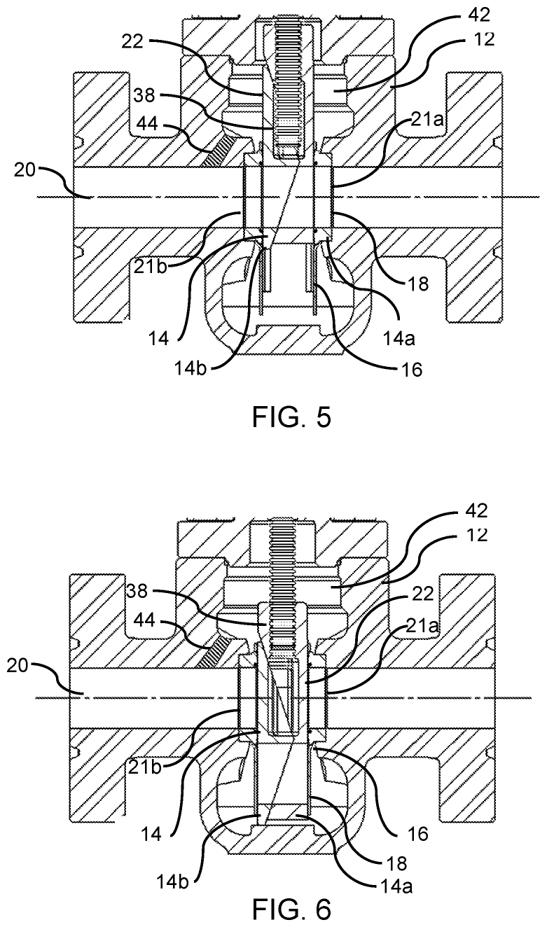

Referring to FIGS. 5 and 6, valve seats 21a and/or 21b may be formed from a material that is able to withstand higher temperatures, such as a temperature of at least 400° F., but that is softer than the metal of valve body 12. A suitable material may include a polytetrafluoroethylene (PTFE) compound that has been designed to resist high temperatures. Other suitable polymers or metal alloys may also be used. In this way, valve seats 21a and 21b, as a softer or more resilient material, are able to maintain contact with valve gate 14 and provide a better seal. In some examples, only the upstream valve seat 21a may be the softer material to prevent valve gate 14 to be pressed away from upstream valve seat 21a. The material selection may be limited by the anticipated fluid temperatures.

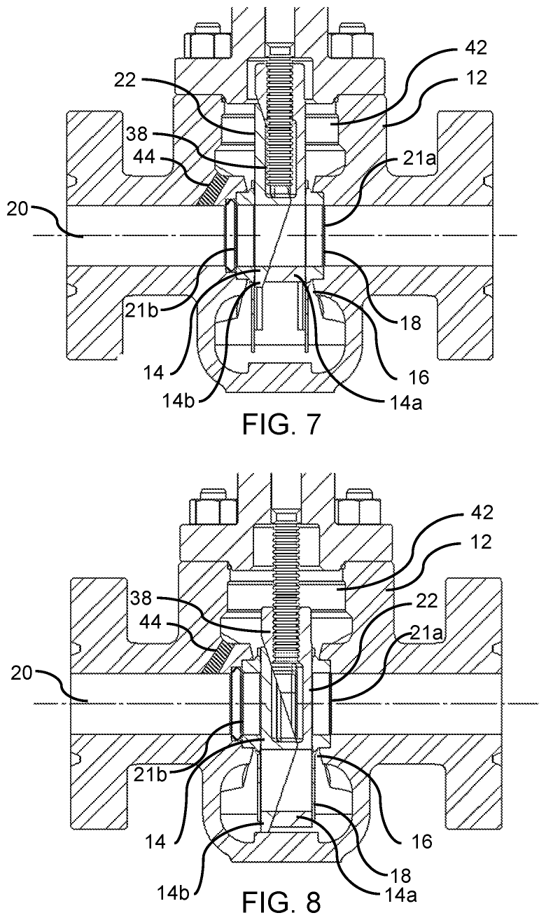

Referring to FIGS. 6 and 7, in another embodiment, a spring 46 may be placed behind downstream valve seat 21b, which will cause valve gate 14 to be pressed against upstream valve seat 21a and encourage a stronger seal on the upstream side of valve gate 14. In this example, downstream valve seat 21b will generally be a hard material, such as metal, while upstream valve seat 21a may be a hard material or soft material. In general, a material will be considered “hard” if it remains substantially undeformed when loads are applied during normal operation of gate valve 10, while a material will be considered “soft” if it is expected to deform when loads are applied under normal operation of gate valve 10.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings but should be given the broadest interpretation consistent with the description as a whole.

What is claimed is:

1. A gate valve, comprising:
a valve body defining a flow passage, the valve body comprising an inner cavity and a gate guide that traverses the flow passage, the valve body comprising an upstream valve seat and a downstream valve seat on opposed sides of the gate guide, where each of the upstream valve seat and the downstream valve seat circumscribe the flow passage;
a valve gate that moves along the gate guide between an open position in which the valve gate permits fluid flow along the flow passage and a closed position in which the valve gate engages the downstream valve seat and the upstream valve seat and blocks fluid flow along the flow passage; and
a drain passage having an inlet in fluid communication with the inner cavity and an outlet in fluid communication with the flow passage downstream of the gate guide.

2. The gate valve of claim 1, wherein the drain passage is formed in an inner surface of the valve body.

3. The gate valve of claim 1, wherein the drain passage comprises a flow channel that extends through a sidewall of the valve body.

4. The gate valve of claim 1, wherein the drain passage bypasses the downstream valve seat.

5. The gate valve of claim 4, wherein the drain passage has an inlet in fluid communication with the gate guide and an outlet in fluid communication with the flow passage.

6. The gate valve of claim 1, wherein the upstream valve seat is made from a polymer rated for temperatures greater than 400° F.

7. The gate valve of claim 1, further comprising a spring that biases the downstream valve seat toward the upstream valve seat such that, with the valve gate in the closed position, the downstream valve seat presses the valve gate into engagement with the upstream valve seat.

8. The gate valve of claim 1, wherein the upstream valve seat and the downstream valve seat are made from hard materials.

9. The gate valve of claim 1, wherein the upstream valve seat and the downstream valve seat are made from non-elastomeric materials.
